(19) United States
(12) Patent Application Publication
(10) Pub. No.: US 2012/0037429 A1
(43) Pub. Date: Feb. 16, 2012

(54) POLYCRYSTALLINE DIAMOND

(76) Inventors: Geoffrey John Davies, Springs (ZA); Johannes Lodewikus Myburgh, Springs (ZA)

(21) Appl. No.: 13/201,166

(22) PCT Filed: Feb. 11, 2010
(86) PCT No.: PCT/IB10/50626

§ 371 Date: Nov. 1, 2011

(30) Foreign Application Priority Data
Feb. 11, 2009 (GB) 0902230.2

(51) Int. Cl. E21B 10/46; B24D 3/10; B01J 3/06

(52) U.S. Cl. 175/428; 51/307; 51/309

(57) ABSTRACT

The present invention relates to polycrystalline diamond (PCD) comprising diamond in granular form, the diamond grains forming a bonded skeletal mass having a network of internal surfaces, the internal surfaces defining interstices or interstitial regions within the skeletal mass, wherein part of the internal surfaces is bonded to a refractory material, part of the internal surfaces is not bonded to refractory material and part of the internal surfaces is bonded to a sintering aid material as well as to a method of making such PCD.

### FIELD

This invention relates to polycrystalline diamond, a method for making same, and elements and tools comprising same, particularly but not exclusively for machining, boring or degrading hard or abrasive materials.

### BACKGROUND

Superhard materials such as diamond are used in a wide variety of forms to machine, bore and degrade hard or abrasive work-pieces or bodies. Superhard materials may be provided as single crystals or polycrystalline structures comprising a directly sintered mass of grains of superhard material forming a skeletal structure, which may define a network of interstices between the grains. Polycrystalline diamond (PCD) is a superhard material comprising a coherent sintered-together mass of diamond grains. The diamond content may typically be at least about 80 volume percent and form a skeletal mass defining a network of interstices. The interstices may contain filler material comprising cobalt. The filler material may be fully or partially removed in order to alter certain properties of the PCD material. Many PCD materials exploited commercially have mean diamond grain size of at least about 1 micron. PCD comprising diamond grains having mean size in the range from about 0.1 micron to about 1.0 micron are also known, and PCD comprising nano-grain size diamond grains having mean size in the range from about 5 nm to about 100 nm have been disclosed.

PCD is extremely hard and abrasion resistant, which is the reason it is the preferred tool material in some of the most extreme machining and drilling conditions, and where high productivity is required. Unfortunately, PCD suffers from several disadvantages, several of which are associated with the metallic binder material typically used. For example, metal binder may corrode in certain applications such as the high speed machining of wood. In addition, metals or metal alloys are relatively soft and susceptible to abrasion, reducing the average wear resistance of the PCD material.

One problematic aspect of PCD is arguably its relatively poor thermal stability above about 400 degrees centigrade, since a PCD element may experience several hundred degrees centigrade at two stages subsequent to sintering. During the tool-making process the PCD element may be attached to a carrier by means of brazing, which involves heating a braze alloy to beyond its melting point. In use, the temperature of the PCD at a working surface may approach 1,000 degrees centigrade in certain applications such as rotary rock drilling. Heat tends to degrade PCD in three principal ways, by inducing thermal stress arising from differences in thermal expansion of the diamond, the binder and the substrate; by inducing the diamond to convert to graphite, which is the thermodynamically stable phase of carbon at ambient pressure; and by oxidation reactions. The former mechanism is believed to become important above about 400 degrees centigrade and becomes progressively more significant as the temperature is increased. The temperature at which the latter mechanism becomes significant depends on the nature, quantity and spatial distribution of the binder material in relation to the diamond. The most commonly used binder metals are selected because they catalyse the sintering of diamond at ultra-high pressures. Unfortunately, these same metals may also catalyse the reverse process of diamond conversion to graphite (or “graphitisation”) at lower pressures. In a typical case where the binder is Co, significant graphitisation is believed occur above about 750 degrees centigrade in air. An important challenge is to devise means of making PCD more refractory, so that its structural integrity, hardness and abrasion resistance are maintained at increasingly higher temperatures. One approach includes the depletion of the binder from a portion of the PCD by acid leaching, leaving a porous layer of PCD with substantially no binder in the interstitial regions.

As is well known in the art, PCD material may be manufactured by subjecting an aggregated mass of diamond grains to an ultra-high pressure and temperature condition at which diamond is thermodynamically stable, in the presence of a sintering aid. The sintering aid may be referred to as a solvent/catalyst material for diamond, examples of which are metals such as cobalt (Co), nickel (Ni), iron (Fe), or certain alloys containing any of these. The ultra-high pressure may be at least about 5.5 GPa and the temperature may be at least about 1,350 degrees centigrade. PCD structures may be integrally bonded to a Co-cemented tungsten carbide (WC) substrate during the sintering process, during which cobalt from the substrate may infiltrate into an the aggregated mass of diamond grains placed against it, and the Co may promote the sintering the diamond grains. Layers or foils of metal may be disposed between the substrate and the aggregated mass of diamond grains so that this layer may provide a source of molten metal to assist or otherwise influence the sintering process.

European patent number 1 775 275 discloses PCD comprising small quantities of carbide forming additives such as titanium, zirconium, hafnium, vanadium, niobium, tantalum, chromium and molybdenum dispersed within the binder.

U.S. Pat. No. 5,370,195 discloses a layer of PCD comprising secondary hard particles of metal carbides and carbo-nitrides dispersed within a Co binder disposed within the interstitial regions.

United States patent publication number 2008/0302579 discloses PCD having improved thermal stability owing to the presence of an intermetallic compound or carbide within a boundary phase intermediate bonded-together diamond crystals.

U.S. Pat. No. 7,473,287 discloses a thermally stable PCD having interstices within a bonded skeletal mass of diamond grains, a first and a second material being disposed within the interstices. The first material is a reaction product formed from a reaction between a solvent/catalyst and another material and the reaction product may have a coefficient of thermal expansion that is relatively closer to that of the diamond than is the coefficient of thermal expansion of the unreacted solvent/catalyst.

### SUMMARY

The purpose of the invention is to provide polycrystalline diamond having enhanced wear resistance, and elements and tools incorporating same.

As used herein, polycrystalline diamond (PCD) is a material comprising a mass of substantially inter-grown diamond grains, forming a skeletal structure defining interstices between the diamond grains, the material comprising at least 80 volume percent of diamond.

As used herein, a refractory material is a material having properties that do not vary significantly with temperature up to at least about 1,100 degrees centigrade, or at least are not substantially degraded on heating to at least this temperature. Non-limiting examples of refractory metals are Ti, V, Cr, Zr, Nb, Mo, Hf, Ta and W. Non-limiting examples of refractory ceramic materials are carbides, oxides, nitrides, borides, carbo-nitrides, boro-nitrides of a refractory metal or of certain other elements. As used herein, a refractory metal carbide is a carbide compound of a refractory metal.

As used herein, a sintering aid is a material that is capable of promoting the sintering-together of grains of a diamond. Known sintering aid materials for diamond include iron, nickel, cobalt, manganese and certain alloys involving these elements. These sintering aid materials may also be referred to as a solvent/catalyst material for diamond. A sintering aid is also capable of promoting the conversion of diamond to graphite at ambient pressure.

The first aspect of the present invention provides polycrystalline diamond (PCD) comprising diamond in granular form, the diamond grains forming a bonded skeletal mass having a network of internal surfaces, the internal surfaces defining interstices or interstitial regions within the skeletal mass, wherein part of the internal surfaces is bonded to a refractory material, part of the internal surfaces is not bonded to refractory material and part of the internal surfaces is bonded to a sintering aid material.

The term “refractory microstructure” is intended to encompass grains, particles or other particulate formations of refractory material.

The refractory microstructures may be disposed on the surface of diamond grains or internal surfaces of the skeletal structure as formations having various forms having various shapes. For example, the refractory microstructures may be granular, reticulated, vermiform or laminar in form, or have other forms or shapes or a combination of forms or shapes.

In one embodiment, the part of the internal surfaces are bonded to refractory microstructures comprising refractory material, and part of the internal surfaces being bonded to a sintering aid material.

In one embodiment, the PCD comprises at least about 5 volume percent refractory material. In some embodiments, the PCD comprises at least about 7, at least about 10 or even at least about 15 volume percent refractory material. In one embodiment, the refractory material has granular form. In one embodiment, the microstructures have a mean size of at least about 0.01 microns, and at most about 0.3 microns, at most about 1 micron or at most about 10 microns. In some embodiments, the refractory material grains are as small as possible in order for the strength and hardness of the diamond element to be high. In some embodiments, the average grain size of the refractory material is optimised to correspond to the Hall-Petch optimum for strength and hardness of the refractory material.

The mechanical properties, in particular the strength, of polycrystalline materials are dependent upon the grain size of the materials. For many materials the relationship between flow stress and grain size is given by the empirical Hall-Petch relation, which implies that any decrease in grain size should increase flow strength. However, the empirical Hall-Petch relationship has been shown to break down for some materials when the grain size becomes sufficiently small, and the plot exhibits a departure from the linear relationship and may even take on a subsequent negative slope for very fine grain sizes.

In some embodiments, the content of diamond is at least about 80 volume percent, at least about 85 volume percent, or at least about 90 volume percent. In some embodiments, the content of diamond is greater than about 95 volume percent, greater than about 97 volume percent, or even greater than about 98 volume percent of a volume of the PCD. In some embodiments, the PCD comprises sintering aid content of less than about 10 percent, less than about 5 percent or even less than about 2 percent by volume.

In some embodiments, at least about 60 percent, at least about 80 percent or even at least about 90 percent of the area of the internal surfaces is bonded to a refractory material.

In one embodiment, the sintering aid comprises nickel. In one embodiment, the refractory microstructures comprise titanium carbide. Such embodiments have the advantage of having enhanced corrosion and wear resistance.

As used herein, cermets are materials comprising metal carbide grains cemented or bonded together by means of a metallic binder, such as Co, Fe, Ni and Cr or any combination or alloy of these, the ceramic and metallic components accounting for respective volume percentages in the ranges from 55 percent to 95 percent, and 45 percent to 5 percent. Non-limiting examples of cermets include Co-cemented WC and Ni-cemented TiC.

In one embodiment, the interstices or interstitial regions contain cermet material.

As used herein, a multimodal size distribution of particles refers to a size distribution, which is understood to mean a graph of number or volume frequency as a function of particle size interval, having at least two peaks, and which is capable of being resolved into two or more distinct uni-modal distributions, a uni-modal distribution having only one peak.

In some embodiments, the PCD comprises diamond grains having mean size of less than about 20 microns, less than about 15 microns or less than about 10 microns. In one embodiment, the PCD comprises diamond grains having a multi-modal size distribution. In some embodiments, the diamond grains have multimodal size distribution and an overall mean size of at least 2 microns or at least 5 microns, and at most 20 microns or at most 10 microns. In some embodiments, the diamond grains have a size distribution having at least two peaks corresponding to two modes, or at least three peaks corresponding to three modes, and in some embodiments, the size distribution has the size distribution characteristic that at least 20 percent of the grains have average size greater than 10 microns, at least 15 percent of the grains have average size in the range from 5 to 10 microns, and at least 15 percent of the grains have average size less than 5 microns.

Embodiments of PCD comprising diamond grains having a multi-modal size distribution exhibit higher packing of grains, which may result in superior homogeneity and enhanced hardness.

In one embodiment, at least part of the PCD is substantially free of sintering aid material for diamond. In one embodiment at least part of the interstices or interstitial regions are substantially free of sintering aid material for diamond. In one embodiment at least part of the interstices or interstitial regions contain at most 10 volume % of the interstitial volume of sintering aid material for diamond. In some embodiments, sintering aid material is selectively removed form at least a region within the PCD, leaving substantial amounts of refractory material within the interstices within the region.

Embodiments of the invention have the advantage of enhanced thermals stability, which may be associated with the selective removal of sintering aid from at least a region of the PCD, and enhanced resistance to oxidation reaction provided by the refractory material. The refractory material may result in enhanced oxidation resistance.

As used herein, an ultra-high pressure is a pressure greater than about 2 GPa and ultra high temperature is above about 750 degrees centigrade.

According to a second aspect of the present invention there is provided a method for making PCD comprising diamond grains, the method including providing an aggregate mass comprising a plurality of diamond grains, part of the surfaces of the diamond grains being coated with refractory material and part of the surfaces not coated with refractory material; and subjecting the aggregated mass in the presence of a sintering aid to an ultra high pressure and temperature at which the diamond is thermodynamically stable.

This aspect of the present invention provides a method for making PCD, the method including providing an aggregate mass comprising a plurality of diamond grains, part of the surfaces of the diamond grains having adhered thereto refractory microstructures comprising a refractory material, and part of the surfaces of the grains being free of adhered refractory microstructures; and subjecting the aggregated mass to an ultra-high pressure and temperature at which the diamond is thermodynamically stable in the presence of a sintering aid. It is important that part of surfaces of the diamond grains do not have refractory microstructures adhered thereto.

An embodiment of the method includes selectively removing sintering aid material from at least part of the PCD. The sintering aid material may be removed by methods known in the art. In one embodiment, the sintering aid material is removed by leaching with an acid liquor.

The following applies equally to all aspects of the present invention. In some embodiments, the refractory microstructures comprise a ceramic material such as carbide, boride, nitride, oxide or carbo-nitride, mixed carbide or inter-metallic material. In one embodiment the refractory microstructures comprise metal carbide and in some embodiments, the refractory microstructures comprise titanium carbide (TiC), tungsten carbide (WC), chromium carbide (Cr₂C₃), tantalum carbide, zirconium carbide, molybdenum carbide, hafnium carbide, boron carbide or silicon carbide.

A used herein, a coating is a formation of a material attached to the surface of a body, the average thickness of the formation being substantially smaller than the average thickness, radius or other characteristic dimension of the body. A partial coating means that the coating does not extend across the entire surface of the body in that parts of the surface of the body remain free of the coating.

In one embodiment, the refractory microstructures are in the form of partial coatings of a refractory material, and in some embodiments the partial coatings exhibit discontinuities or gaps where portions of the surfaces of the diamond grains are not covered by refractory material. In one embodiment, the partial coating of refractory material and the discontinuities associated with it are dispersed substantially homogeneously over the surface of each diamond grain.

In one embodiment, the mean size scale of the refractory microstructures is greater than about 0.01 microns and less than about 0.5 microns. In one embodiment, the mean thickness of the refractory microstructures as measured from the surfaces of the diamond grains to which they are bonded is less than about 500 nanometres.

Embodiments of the invention provide PCD material having superior mechanical properties, such as abrasion resistance, or having enhanced thermal stability. Embodiments of the method provide such PCD material relatively more economically and easily than known methods.

In some embodiments, most but not all of the surface area of the diamond grains is protectively coated with a refractory material. In some embodiments, the refractory microstructures cover more than about 50 percent and less than about 98, 95 or 90% percent of the surface area of the diamond grains, on average. In one embodiment, the mean volume of refractory material partially coating the diamond grains does not exceed about 30% of the mean volume of the diamond grains.

Embodiments of the invention have the advantage that the quantity and arrangement of sintering aid in relation to the diamond grains is, one the one hand, sufficient to support the sintering together of the grains at a pressure at which the diamond is thermodynamically stable, but on the other hand, reduces the rate of thermal degradation of the sintered PCD at temperatures experienced in use.

In one embodiment, the diamond grains additionally have a coating or partial coating comprising a sintering aid material, and in one embodiment, at least some of the sintering aid material is in direct contact with the surfaces of the diamond grains. In one embodiment, the coating or partial coating of sintering aid material has an average thickness of at most about 1 micron or even at most about 0.5 microns. In some embodiments, the sintering aid material is interspersed among the formations of refractory material, or it wholly or partially encapsulates or envelopes the diamond grain and the refractory material, or it is disposed as a layer or layers on the refractory material formations.

In one embodiment, the sintering aid coating or partial coating comprises a surface to which is attached a film comprising non-diamond carbon, and in some embodiments, the film has a mean thickness of less than about 100 nanometres or even less than about 20 nanometres.

In some embodiments, the presence of a carbonaceous film may promote the precipitation of diamond during the step of subjecting the aggregated mass to an ultra-high pressure, and consequently may promote the formation of a coherently bonded PCD.

Embodiments of the method of the invention provide significant control and flexibility in the manufacture of PCD and their microstructures and characteristics. In particular, the end product may contain a high volume fraction of diamond and relatively small amounts of sintering aid material, which may improve the thermal stability of embodiments.

Another aspect of the invention provides a PCD element comprising an embodiment of a PCD according to an aspect of the invention.

In one embodiment, the PCD element comprises a region that is substantially free of sintering aid material for diamond. In one embodiment, the region is adjacent a surface. In one embodiment, the region is in the form of a stratum extending a depth from a working surface (i.e. a surface that may be exposed to a workpiece or formation in use). Embodiments of invention, particularly embodiments including a region substantially free of sintering aid material for diamond, have the advantage of displaying enhanced resistance to oxidation reactions involving the diamond.

Another aspect of the invention provides an insert for a machine tool or drill bit, comprising an embodiment of a PCD element according to an aspect of the invention. In one embodiment, the insert is for a drill bit for boring into the earth or drilling through rock.

Embodiments of inserts have the advantage of enhanced thermal stability where the PCD element may be exposed to elevated temperatures exceeding about 400 degrees centigrade during a tool or bit manufacturing step or in use. Examples of applications of embodiments are pavement degradation, mining, machining, including turning, milling, drilling and certain wear applications. Embodiments may also have the advantage of enhanced wear or corrosion resistance.

Another aspect of the invention provides a tool comprising an embodiment of an insert according to an aspect of the invention. In some embodiments, the tool comprises a drill bit for rock drilling in the oil and gas industry, especially in so-called fixed cutter, shear or drag bits.

### DRAWINGS

Non-limiting embodiments will now be described with reference to the figures, of which:

FIG. 1 shows a schematic diagram of the microstructure of an embodiment of PCD according to the present invention.

FIG. 2 shows a scanning electron micrograph of a polished cross-section of an embodiment of PCD according to the present invention. An expanded area of the micrograph is shown as an inset. XRD spectra corresponding to two different points on the section are also shown.

FIG. 3A to FIG. 3E show schematic diagrams of cross sections of diamond grains having a partial, discontinuous coating of refractory microstructures and various configurations and combinations of metallic coatings.

FIG. 4 shows a scanning electron micrograph of embodiments of coated diamond grains.

FIG. 5 shows an X-ray diffraction trace of the embodiment of coated diamond grains shown in FIG. 4.

FIG. 6 shows a transmission electron micrograph (TEM) of an embodiment of refractory microstructures disposed on a diamond grain (not shown).

FIG. 7 shows a multimodal size distribution of diamond grains within an embodiment of PCD.

The same references refer to the same features in all drawings.

### DETAILED DESCRIPTION OF EMBODIMENTS

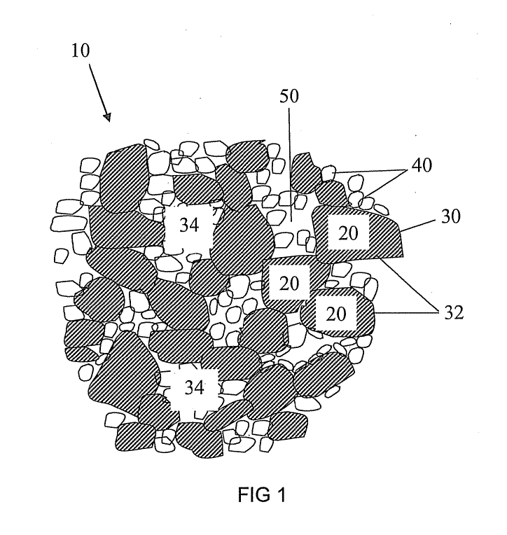

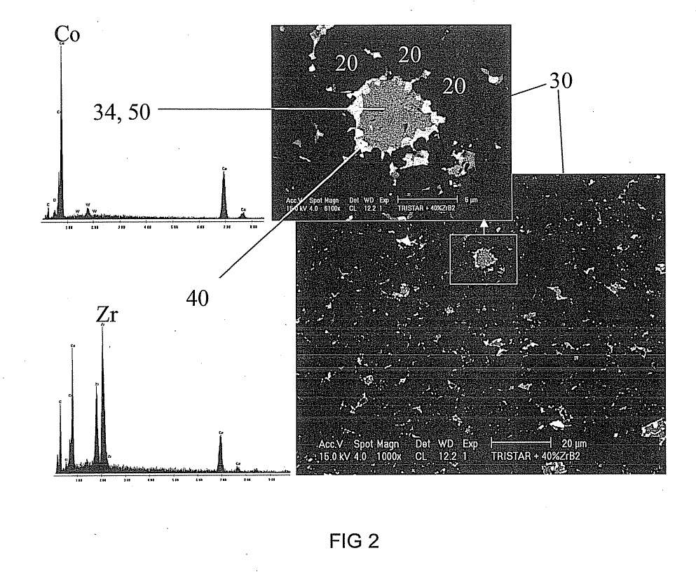

With reference to FIG. 1 and FIG. 2, an embodiment of PCD 10 comprises diamond grains 20 directly inter-bonded to form a skeletal mass 30 having a network of internal surfaces 32, the internal surfaces 32 defining interstices or interstitial regions 34, part of the internal surfaces 32 being bonded to refractory microstructures 40 comprising refractory material, and part of the internal surfaces 32 being bonded to a sintering aid material 50.

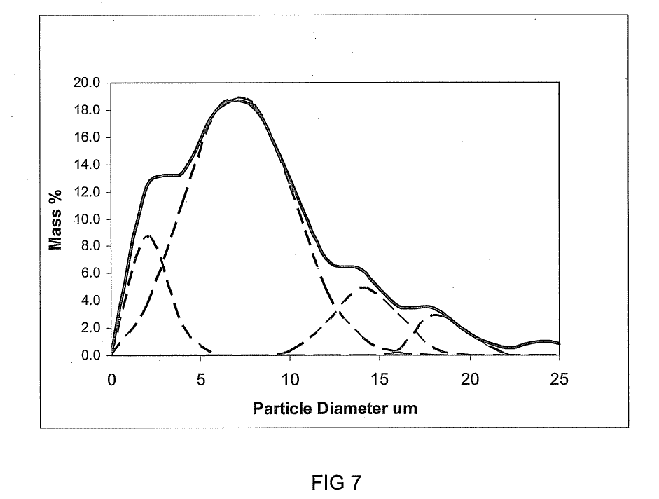

With reference to FIG. 2, an embodiment of PCD has a microstructure bonded grains of diamond 20, granular refractory microstructures 40 bonded to the diamond grains and forming an interconnected network of refractory microstructures comprising ZrB₂, and a metallic material 50 comprising Co, which fills interstices 34 and is substantially, but not completely, segregated from the diamond grains 20 by the refractory microstructures 40. The polycrystalline skeletal mass 30 defines interstices or interstitial regions 34 within the skeletal mass 30 of diamond grains 20, the interstices or interstitial regions 34 being defined by an internal network of diamond surfaces. The diamond surfaces are in direct contact with both the refractory microstructures 40 and the Co material 50. The PCD of this embodiment comprises diamond grains having the multimodal size distribution shown in FIG. 7. The size distribution of the diamond grains within the element was measured by means of image analysis carried out on a polished surface of the element.

The general material structures and compositions of the invention encompass embodiments of PCD having a continuous inter-grown network of diamond and an interpenetrating network of metal carbide structures. Each diamond grain is bonded to surrounding diamond grains and is also in contact with the continuous network of ceramic and metallic material.

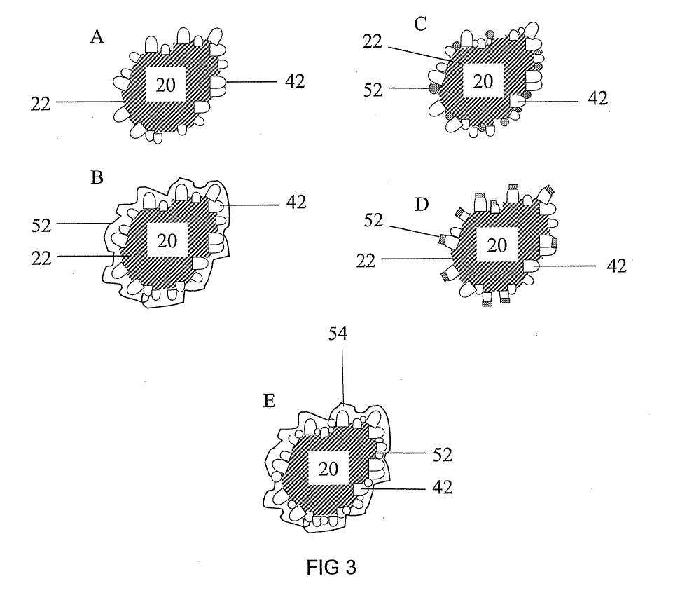

With reference to FIG. 3A to FIG. 3E, embodiments of the method include providing an aggregate mass comprising a plurality of diamond grains, of which a single diamond grains 20 are shown, part of the surfaces 22 of the diamond grains 20 having adhered thereto refractory microstructures 42 comprising a refractory material, and part of the surfaces 22 of the grains being free of adhered refractory microstructures 42; and subjecting the aggregated mass to an ultra-high pressure and temperature at which the diamond is thermodynamically stable in the presence of a sintering aid. In one embodiment, the refractory microstructures 42 are present as substantially discontinuous formations, forming a partial coating having the form of “islands” or “patches” of material bonded to the surface of the diamond grain 20. In one embodiment with reference to FIG. 3B, the diamond grain 20 has a further coating 52 comprising a sintering aid for diamond, for example a metallic solvent/catalyst material for diamond, the further coating 52 being more continuous than the partial coating of refractory microstructures 42 and the further coating 52 encapsulating or enveloping the diamond grain 20 and a substantial fraction of the refractory microstructures 42. In an embodiment with reference to FIG. 3C, the further coating 52 is discontinuous and substantially intercalated or interspersed among the refractory microstructures 42. In an embodiment with reference to FIG. 3D, the further coating 52 is discontinuous and disposed as a coating on the refractory microstructures 42. In an embodiment with reference to FIG. 3E, the further coating 52 is discontinuous and substantially intercalated among the formations of refractory material, and there is yet a further coating 54 comprising a sintering aid for diamond, the yet further coating 54 being more continuous than the partial coating of refractory microstructures 42 and encapsulating or enveloping the diamond grain 20 as well as a substantial fraction of the refractory microstructures 42 and the further coating 52.

In one embodiment, the sintering aid material comprises a metal or metal alloy capable of dissolving material from the diamond grains when the metal or metal alloy is in a molten state, and capable of promoting the precipitation and growth of diamond at pressures and temperatures at which diamond is thermodynamically stable. During the step of subjecting the aggregated mass to an ultra-high pressure, the aggregated mass is heated to a temperature sufficient to melt the metal or metal alloy. The molten metal or metal alloy material may function to dissolve and transport atoms or molecules from the diamond grains. If the applied ultra-high pressure and temperature conditions are such that diamond is thermodynamically stable, the atoms or molecules may precipitate in the form of the diamond, preferentially proximate regions where adjacent diamond grains are close together. This may result in the formation of diamond necks connecting adjacent diamond grains, and consequently the formation of a coherently bonded PCD element.

Various methods of depositing a coating of sintering aid material onto grains are well known in the art, and include chemical vapour deposition (CVD), physical vapour deposition (PVD), sputter coating, electrochemical methods, electroless coating methods and atomic layer deposition. The skilled person would appreciate the advantages and disadvantages of each, depending on the nature of the sintering aid material and coating structure to be deposited, and on characteristics of the grain. In some embodiments of the method of the invention, atomic layer deposition (ALD) and CVD are used for depositing sintering aid material after the deposition of the refractory material, but are not preferred for depositing the refractory material since the resultant coating would tend to be continuous. A method for depositing a partial refractory coating onto grains, in particular for depositing metal carbide onto diamond, or metal nitride onto cBN, is disclosed in PCT publication number WO 2006/032982. Suitable coating methods are also described in PCT patent publication number 2006/032984. A method employing atomic layer deposition (ALD) may be used to deposit a continuous coating of sintering aid material for diamond. A method is disclosed in US patent application publication number 2008/0073127.

Known sintering aid materials for diamond include iron, nickel, cobalt, manganese and certain alloys involving these elements. These sintering aid materials may also be referred to as a solvent/catalyst material for diamond. In one embodiment, Co or Ni may be precipitated onto diamond grains by a method involving the precipitation of precursor compounds, such as carbonates. The deposited precursor material may then be converted to an oxide by means of pyrolysis, and the oxide may then be reduced to yield the metal or metal carbide. Equation (1) below is an example of a reaction for Co or Ni nitrates and sodium carbonate reactant solution to form Co and/or Ni carbonate as the precipitated precursor compound combining with the oxide precursor already formed.

(Co or Ni)(NO₃)₂+Na₂CO₃->(Co or Ni)CO₃+2NaNO₃ (1)

Examples of pyrolysis reactions involving cobalt or nickel carbonates are as follows:

(Ni)CO₃->(Ni)O+CO₂ (2)

(Ni)O+H₂->Ni+H₂O (3)

A suggested exemplary reaction for the carbo-thermal reduction and formation of one of the preferred carbide components of the ceramic, namely tantalum carbide, TaC is given in equation (4).

2Ta₂O₅+9C->4TaC+5CO₂ (4)

This reaction is suitable for obtaining some of the preferred cermets, such as TaC/Co or TaC/Ni.

For example, TaC may be deposited on to the diamond grains according to the invention by depositing a precursor material comprising tantalum oxide, Ta₂O₅, onto the grains surface at a temperature of about 1,375 degrees centigrade. Alternatively, some precursor materials for certain carbides may readily be reduced by hydrogen. For example, tungstic oxide, WO₃, is a suitable precursor for producing tungsten carbide, WC, and molybdic oxide, MoO₃, is a suitable precursor to form molybdenum carbide, Mo₂C.

In one embodiment of the method, a plurality of diamond particles coated with a partial, discontinuous coating of metal carbide and a discontinuous coating comprising cobalt, iron or nickel, or a combination or alloy of any of these, is formed into a pre-form, the pre-form comprising an aggregated mass, the plurality of diamond grains being held together buy means of a binder, as is known in the art. The pre-form is disposed onto and contacted with a substrate to which it is intended to bond, the substrate comprising a cemented carbide hard-metal such as WC—Co or some other type of cermet. Sintered bodies integrally formed and bonded to such a substrate are referred to as “backed” bodies, and those without an integrally bonded substrate are referred to as “unbacked” bodies. The pre-form is assembled into a capsule suitable for loading into an ultra-high pressure furnace, as is well known in the art, and subjected to an ultra-high pressure of greater than about 5.5 GPa and a temperature of greater than about 1,200 degrees centigrade in order to sinter the diamond particles into a coherent bonded polycrystalline mass, as is well known in the art. In general, where the amount of diamond within the polycrystalline element is greater than about 95 volume percent, higher than normal pressures and/or temperatures may be required to sinter the diamond grains.

In one embodiment, the particulates on the diamond surface do not comprise substantially any metal or alloy capable of sintering diamond grains, and such sintering catalyst is introduced by admixing it in powder form into the pre-form or alternatively or additionally infiltrating molten material from a substrate into the pre-form.

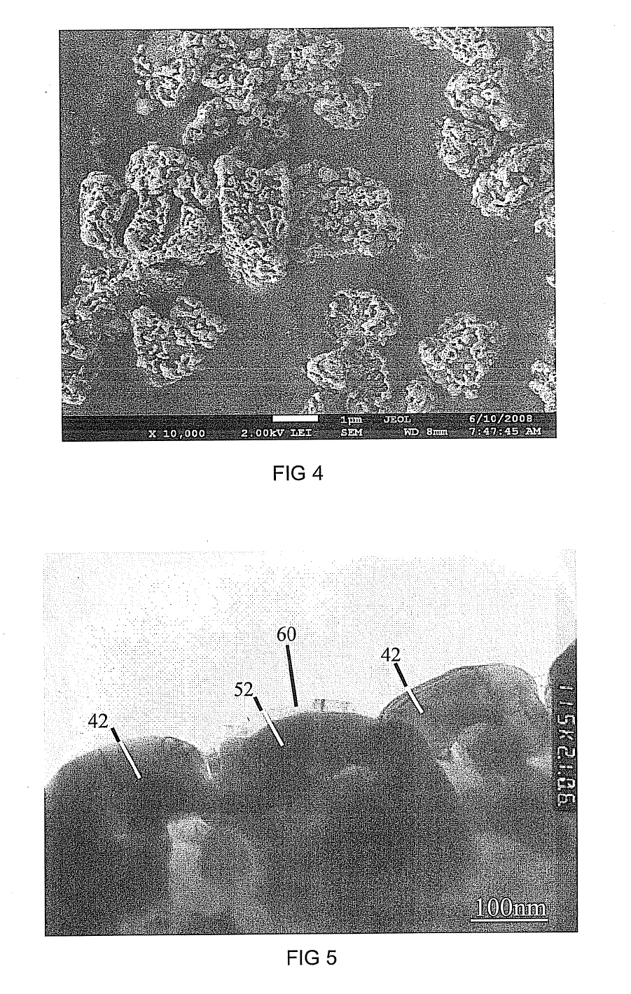

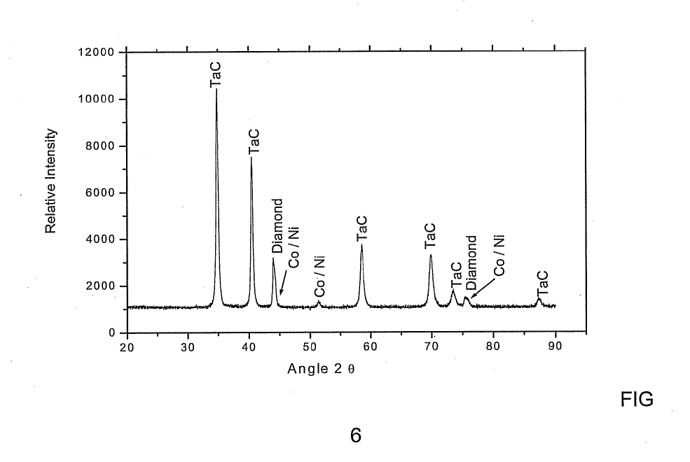

With reference to FIG. 4, an embodiment of a plurality of coated diamond grains has a mean size of approximately 2 microns and the grains have a partial coating of refractory microstructures comprising TaC, and a partial coating of Ni as the metallic material. As shown in FIG. 5 The XRD analysis of the coated grains showed that each 2 micron diamond particle was decorated in nano-sized particulates comprising tantalum carbide and nickel, TaC/Ni. This is consistent with the nickel enhanced carbo-thermal reduction of the tantalum oxide, Ta₂O₅, precursor on the diamond surface to form TaC. From a standard Scherrer analysis of the XRD data, the grain size of the TaC was estimated to be about 40 to 60 nm in size.

With reference to FIG. 6, an embodiment of a nano-scale nickel microstructure 52 and nano-scale refractory microstructures 42 comprising TaC disposed on a diamond grain (not shown). The nickel coating 52 has a thin film of amorphous carbon 60 formed thereon. The embodiment shown in FIG. 6 was obtained by carbothermal reduction of the coating described with reference to FIG. 4.

Multimodal PCD is disclosed in U.S. Pat. Nos. 5,505,748 and 5,468,268 and the multimodal grain size distribution of an embodiment of PCD is shown in FIG. 7. Multimodal polycrystalline elements are typically made by providing more than one source of a plurality of grains or particles, each source comprising grains or particles having a substantially different average size, and blending together the grains or particles from the sources. Measurement of the size distribution of the blended grains reveals distinct peaks corresponding to distinct modes. The blended grains are then formed into an aggregate mass and subjected to a sintering step at high or ultra-high pressure and elevated temperature, typically in the presence of a sintering agent. The size distribution of the grains is further altered as the grains impinge one another and are fractured, resulting in the overall decrease in the sizes of the grains prior to sintering. Nevertheless, the multimodality of the grains is usually still clearly evident from image analysis of the sintered article.

Whilst wishing not to be limited to a particular theory, the partial coating of diamond surfaces by refractory microstructures may function to protect the diamond grains of the end product against dissolution or other degradation, particularly at an elevated temperature in use. In particular, the refractory microstructures may function as a protective barrier, preventing or hindering sintering aid material typically present within the diamond element from reacting with and degrading the diamond when the diamond element is in use at elevated temperatures. It may also function to enhance mechanical (wear resistance, for example) and thermal properties of the PCD element by, for example, minimising the amount of sintering aid material within the element.

In one embodiment, substantially all of the surface area of the diamond grains is in contact with refractory microstructures or sintering aid material. The refractory microstructures should cover as much of the surface area of the diamond grains as possible without substantially hindering or preventing a sintering aid from contacting an area of the surface of the diamond grains during the step of applying ultra-high pressure and temperature, the area being high enough for sintering between diamond grains to take place. If the area of contact between the sintering aid and the diamond grains is too small, the sintering aid will not be able to function effectively to promote the formation of direct bonds between the diamond grains. On the other hand, the larger this area, the more the sintering aid may react with the diamond grains when the PCD is subjected to high temperatures in use, which may deleteriously affect properties of the element. A strongly bonded polycrystalline material having a very superior thermal stability may be formed on the basis of these principles.

Sintering aid may be sourced from a coating of the diamond grains, powder admixed with the diamond grains or from a body contacted with the aggregate mass, or from any combination of these sources. The contacted body is preferably a substrate comprising cobalt-cemented tungsten carbide, the cobalt from the substrate preferably infiltrating the aggregate mass during the ultra-high pressure step. Where the grains have a metallic coating or partial coating, the metal or metals of the coatings on the grains need not be the same as the metal or metals present in the substrate.

The respective parts of the internal surfaces do not need to be continuously covered by the refractory material or the sintering aid material to which they are bonded, and may be discontinuous. In one embodiment, each respective part is substantially homogeneously discontinuous.

### EXAMPLES

Embodiments of the invention are described in more detail with reference to the examples below, which are not intended to limit the invention.

### Example 1

PCD was manufactured using a starting powder comprising synthetic diamond powder having a mean size of about 2 microns. The ceramic phase within the end product comprised tantalum carbide, TaC, as the major ceramic component and tungsten as a minor component, and the metallic phase was an alloy comprising nickel and cobalt. The diamond was sintered and integrally bonded to a Co-cemented WC substrate during the ultra-high pressure sintering step. The PCD of this example was made by a process including the following steps:

Coating with Precursor for Metal Carbide
i. 100 g of diamond powder comprising diamond grains having a mean size of about 2 microns was suspended in 2 litre of ethanol, C₂H₅OH. A solution of tantalum ethoxide, Ta(OC₂H₅)₅ in dry ethanol and separate aliquot of water and ethanol was slowly and simultaneously added to this suspension while vigorously stirring. The tantalum ethoxide solution comprised 147 g of ethoxide dissolved in 100 ml of anhydrous ethanol. The aliquot of water and ethanol was made by combining 65 ml of de-ionised water with 150 ml of ethanol. In the stirred diamond/ethanol suspension, the tantalum ethoxide reacted with the water and formed a coat of amorphous, micro-porous tantalum oxide, Ta₂O₅ on the diamond particles.
ii. The coated diamond was recovered from the alcohol after a few repeated cycles of settling, decantation and washing with pure ethanol. The powder was then made substantially alcohol free by heating at 90 degrees centigrade.
   Coating with Precursor for Metallic Nickel
iii. The coated diamond powder was then re-suspended in 2.5 litres of de-ionised water. To this suspension an aqueous solution of nickel nitrate, Ni(NO₃)₂ and an aqueous solution of sodium carbonate, Na₂CO₃ were slowly and simultaneously added while the suspension was vigorously stirred. The nickel nitrate aqueous solution was made by dissolving 38.4 g of Ni(NO₃)₂.6H₂O crystals in 200 ml of de-ionised water. The sodium carbonate aqueous solution was made by dissolving 14.7 g of Na₂CO₃ crystals in 200 ml of de-ionised water. The nickel nitrate and slightly excess sodium carbonate reacted in the suspension and precipitated nickel carbonate crystals.
iv. The sodium nitrate product of the precipitative reaction, together with any un-reacted sodium carbonate was then removed by a few repeated cycles of decantation and washing in de-ionised water. After a final wash in pure alcohol the coated, decorated diamond powder was dried under vacuum at 90 degrees centigrade.

### Heat Treatment to Convert Precursors Respectively to TaC and Ni

The dried powder was then placed in an alumina boat with a loose powder depth of about 5 mm, and heated in a flowing stream of 10% hydrogen gas in pure argon. The top temperature of 1100 degrees centigrade was maintained for 3 hours and then the furnace cooled to room temperature.

### Sintering at Ultra-High Pressure and Temperature

The coated powder was then placed in contact with fully dense tungsten carbide, 13 percent cobalt hard metal substrates and subjected to a pressure of about 5.5 GPa and a temperature of about 1400 degrees centigrade in a belt type high pressure apparatus, as is well established in the art of PCD composite manufacture. The resultant PCD element was bonded to cobalt-cemented tungsten carbide substrate. Some cobalt from the substrate had infiltrated the PCD, resulting in a binder being an alloy comprising both nickel and cobalt. The embodiment of PCD produced in this example comprised interpenetrating networks of inter-grown diamond and TaC/WC microstructures. The metallic binder was an alloy comprising cobalt and nickel. The source of the cobalt and tungsten within the PCD was the molten metal infiltrated into the aggregated mass of diamond grains coated with a coating comprising TaC and Ni according to the invention.

Polished cross-section samples of the PCD layer were prepared and characterised using image analysis techniques on the SEM. The relative areas of the diamond, carbide and binder metal phases are given in table 1. These area proportions correspond closely to the volume composition of the material.

TABLE 1

| | Diamond | Ta, W carbide | Co/Ni binder |
|---|---|---|---|
| Mean Area % | 72.32 | 15.24 | 12.45 |
| Std dev | 0.64 | 0.59 | 0.34 |

The image analysis showed that the ratio of the volume of diamond to the combined volume of ceramic and metallic materials was about 72:28 and the volume ratio of the carbide ceramic to the metallic material was 55:45.

Energy Dispersive X-ray Spectra analysis, EDS was also undertaken on the SEM at seven separate 170 by 170 micron areas of a polished cross-section. This technique readily provides the relative metallic elemental content. The EDS data and calculated mass and volume proportions of the ceramic and metallic components are given in table 2.

TABLE 2

| | Ta | W | Co | Ni | TaC | WC |
|---|---|---|---|---|---|---|
| Atomic % | 37.96 | 4.04 | 47.62 | 10.38 | | |
| Weight % | 62.30 | 6.73 | 25.45 | 5.52 | | |
| Weight % | | | 24.43 | 5.28 | 63.53 | 6.86 |
| Volume % | | | 34.12 | 7.32 | 53.10 | 5.46 |

In this analysis it was assumed that each tantalum and tungsten atom would have one carbon atom associated with it as a carbide structure. This assumption is valid because the material sintering reactions took place in an environment with a vast excess of carbon, that is, a highly carburising environment. The formation of non-stoichiometric carbon deficient carbides is therefore considered to be highly unlikely. From this analysis, it was established that the ratio of the ceramic volume to the metal volume was about 59:41.

The carbide component of the network was shown to be predominantly tantalum carbide based, as the atomic ratio of Ta to W was in the region of 9 to 1. At ratios such as this it is expected that the carbide will be ternary TaₓW_{y}C carbide, where x is about 0.9 and y about 0.1, with of the sodium chloride B1 structure. FIG. 7 is an XRD spectrum confirming the presence of diamond, TaC and Co/Ni dominant phases. This XRD analysis is unable to confirm the expected Ta_{0.9}W_{0.1}C ternary phase as the lattice parameter shift for this proportion of W in solution in the TaC lattice is too small. However no WC phase was detected, so the analysis is consistent with the single carbide phase being Ta_{0.9}W_{0.1}C.

### Example 2

PCD material was made from synthetic diamond powder having a mean size of about 2 microns. The PCD comprised a ceramic interstitial phase of titanium carbide with some tungsten component and a metallic interstitial phase comprising nickel and cobalt alloy. The PCD was integrally bonded to a Co-cemented WC substrate during the ultra-high pressure sintering step. The PCD of this example was made by a process including the following steps:

Coating with Precursor for Metal Carbide:
i. 60 g of 2 micron diamond powder was suspended in 750 ml of ethanol, C₂H₅OH. To this suspension, while maintaining vigorous stirring, a solution of titanium iso-propoxide, Ti (OC₃H₇)₄ in dry ethanol and separate aliquot of water and ethanol was slowly and simultaneously added. The titanium iso-propoxide solution was made from 71 g of the alkoxide dissolved in 50 ml of anhydrous ethanol. The aliquot of water and ethanol was made by combining 45 ml of de-ionosed water with 75 ml ethanol. In the stirred diamond/ethanol suspension, the titanium iso-propoxide reacted with the water and formed a coat of amorphous, micro-porous titamium oxide, TiO₂, on each and every particle of diamond.
ii. The coated diamond was recovered from the alcohol after a few repeated cycles of settling, decantation and washing with pure ethanol.
   Coating with Precursor for Metallic Nickel
iii. This coated diamond powder was then re-suspended in 2.5 litres of de-ionised water. To this suspension an aqueous solution of nickel nitrate, Ni(NO₃)₂ and an aqueous solution of sodium carbonate, Na₂CO₃ were slowly simultaneously added while the suspension was vigorously stirred. The nickel nitrate aqueous solution was made by dissolving 38.4 g of Ni(NO₃)₂.6H₂O crystals in 200 ml of de-ionised water. The sodium carbonate aqueous solution was made by dissolving 14.7 g of Na₂CO₃ crystals in 200 ml of de-ionised water. The nickel nitrate and slightly excess sodium carbonate reacted in the suspension and precipitated nickel carbonate crystals.
iv. The sodium nitrate product of the precipitative reaction, together with any un-reacted sodium carbonate was then removed by a few repeated cycles of decantation and washing in de-ionised water. After a final wash in pure alcohol the coated, decorated diamond powder was dried under vacuum at 90 degrees centigrade.

### Heat Treatment to Convert Precursors Respectively to TaC and Ni

The dried powder was then placed in an alumina boat with a loose powder depth of about 5 mm, and heated in a flowing stream of 10 percent hydrogen gas in pure argon. The top temperature of 1200 percent was maintained for 3 hours and then the furnace cooled to room temperature.

### Sintering at Ultra-High Pressure and Temperature

The coated powder was then placed in contact with fully dense tungsten carbide, 13% cobalt hard metal substrates and subjected to a pressure of about 5.5 GPa and a temperature of about 1400 degrees centigrade in a belt type high pressure apparatus, as well established in the art of PCD composite manufacture. The resultant PCD element was bonded to cobalt-cemented tungsten carbide substrate. Some cobalt from the substrate had infiltrated the PCD, resulting in a binder being an alloy comprising both nickel and cobalt. The ratio of the volume of diamond to the combined volume of ceramic and metal within the PCD was about 74:26 and the ratio of the volume of carbide ceramic material to the volume of metallic material was 75:25. The results of EDS analysis of the sample are shown in table 3.

TABLE 3

| | Ti | W | Co | Ni | TiC | WC |
|---|---|---|---|---|---|---|
| Atomic % | 59.31 | 2.77 | 32.63 | 5.29 | | |
| Weight % | 50.81 | 9.12 | 34.42 | 5.65 | | |
| Weight % | | | 30.36 | 4.99 | 56.07 | 8.58 |
| Volume % | | | 21.41 | 3.52 | 71.52 | 3.55 |

The PCD comprised interpenetrating networks of inter-grown diamond and titanium/tungsten carbide, (Ti,W)C.

The carbide component of the network was shown to be predominantly titanium carbide based, as the atomic ratio of Ti to W was in the region of 20 to 1. It is well known that titanium carbide, TiC with the sodium chloride, B1 structure can accommodate certain amounts of other carbide forming transition metals, such as W, and maintain it's structure. The general formula for such a carbide is TiₓW_{y}C, where x+y=1. With the ratios of table 3, a credible carbide material for this embodiment is Ti_{0.95}W_{0.05}C. The XRD analysis was consistent with this interpretation.

### Example 3

PCD material pieces were made from synthetic diamond powder having a mean size of about 2 microns and final composition including titanium carbide with some tungsten component and with cobalt based binder. Nickel was absent from this material. The PCD was integrally bonded to a Co-cemented WC substrate during the ultra-high pressure sintering step.

The same process was used as in example 2, save only that cobalt nitrate crystals, Co(NO₃)₂.6H₂O was used instead of nickel nitrate. Cobalt thus replaced nickel in the enhanced carbo-thermal reduction of the TiO₂ on the diamond surfaces. Cobalt carbonate, CoCO₃ was the precursor for the Co.

The TiC/Co-coated 2 micron diamond powder was then placed in contact with fully dense tungsten carbide, 13 percent cobalt hard metal substrates and subjected to a pressure of about 5.5 GPa and a temperature of about 1400 degrees centigrade in a belt type high pressure apparatus, as well established in the art of PCD composite manufacture. The ratio of the volume of diamond to the combined volume of the ceramic and metallic materials was about 72:28. The calculated mass and volume proportions of the ceramic and metal components of this example are given in table 4.

TABLE 4

| | Ti | W | Co | TiC | WC |
|---|---|---|---|---|---|
| Atomic % | 56.56 | 2.84 | 40.60 | | |
| Weight % | 48.15 | 9.29 | 42.56 | | |
| Weight % | | | 37.77 | 53.44 | 8.79 |
| Volume % | | | 27.09 | 69.32 | 3.59 |

The PCD comprised interpenetrating networks of inter-grown diamond and titanium/tungsten carbide, (Ti,W)C.

From this analysis the weight ratio of the ceramic to the cobalt metal constituents was about 62:38, corresponding to a volume ratio of about 73:27. In this case the cobalt binder is sourced both from the infiltrated metal from the WC/Co hard metal substrate and the cobalt decorated onto the diamond powder. The source of the W was solely from the infiltrating metal.

The atomic ratio of Ti to W was in the region of 20 to 1 and so the expected carbide phase is Ti_{0.95}W_{0.5}C, with the cubic sodium chloride B1 structure. The XRD analysis was consistent with this interpretation.

### Example 4

60 g of diamond grains having average size of about 2 microns was coated with TiC as in example 2. No additional coating of metal was provided, and the TiC-coated grains were sintered at ultra-high pressure and temperature as in example 2. The cobalt sintering aid for promoting the inter-growth of the diamond grains was sourced from the cobalt-cemented tungsten carbide substrate, as is known in the art. Molten cobalt infiltrated the diamond pre-form during the sintering step, resulting in the intergrowth of diamond grains and a PCD element having an interpenetrating network of TiC within the interstices, a substantial portion of the TiC bonded to the diamond and segregating much of the infiltrated cobalt from the diamond, thereby enhancing the thermal stability of the element.

1. Polycrystalline diamond (PCD) comprising diamond in granular form, the diamond grains forming a bonded skeletal mass having a network of internal surfaces, the internal surfaces defining interstices or interstitial regions within the skeletal mass, wherein part of the internal surfaces is bonded to a refractory material, part of the internal surfaces is not bonded to refractory material and part of the internal surfaces is bonded to a sintering aid material.

2. Polycrystalline diamond (PCD) as claimed in claim 1 comprising diamond grains directly inter-bonded to form a skeletal mass and wherein the refractory material is in the form of refractory microstructures.

3. PCD as claimed in or claim 2 comprising at least 5 volume percent refractory material.

4. PCD as claimed in claim 2, the microstructures having a mean size of at least 0.01 microns and at most 10 microns.

5. PCD as claimed in claim 1, the content of diamond being greater than 80 volume percent of a volume of the PCD.

6. PCD as claimed in claim 1, the PCD comprising less than 10 percent by volume sintering aid material.

7. PCD as claimed in claim 1, at least 60 percent of the area of the internal surfaces being bonded to refractory material.

8. PCD as claimed in claim 1, the sintering aid comprising nickel.

9. PCD as claimed in claim 2, the refractory microstructures comprising titanium carbide.

10. PCD as claimed in claim 1, the interstices or interstitial regions contain cermet material.

11. PCD as claimed in claim 1, at least part of the interstices or intersitital regions substantially free of sintering aid material for diamond.

12. A method for making PCD comprising diamond grains, the method including the steps of subjecting an aggregate mass comprising a plurality of diamond grains, part of the surfaces of the diamond grains being coated with refractory material and part of the surfaces not coated with refractory material, in the presence of a sintering aid to an ultra high pressure and temperature at which the diamond is thermodynamically stable.

13. A method for making PCD as claimed in claim 12, part of the surfaces of the diamond grains having adhered thereto refractory microstructures comprising a refractory material, and part of the surfaces of the grains being free of adhered refractory microstructures.

14. A method as claimed in claim 11, the refractory material comprising carbide, boride, nitride, oxide or carbo-nitride, mixed carbide or inter-metallic material.

15. A method as claimed in claim 13, the refractory microstructures having a mean size scale of greater than 0.01 microns and less than 0.5 microns.

16. A method as claimed in claim 13, the refractory microstructures covering more than 50 percent and less than 98 percent of the surface area of the diamond grains.

17. A method as claimed in claim 12, the diamond grains additionally having a coating or partial coating comprising a sintering aid material for diamond.

18. A PCD element comprising the PCD as claimed in claim 1 or made using a method as claimed in claim 12.

19. An insert for a machine tool or drill bit, comprising a PCD element as claimed in claim 18.

20. A tool comprising an insert as claimed in claim 20.
